(19) United States
(12) Patent Application Publication
(10) Pub. No.: US 2013/0075469 A1
(43) Pub. Date: Mar. 28, 2013

(54) My Vacation Card

(71) Applicant: Silviu Stochita, Ottawa (CA)

(72) Inventor: Silviu Stochita, Ottawa (CA)

(21) Appl. No.: 13/630,422

(22) Filed: Sep. 28, 2012

Related U.S. Application Data
(60) Provisional application No. 61/540,201, filed on Sep. 28, 2011.

(51) Int. Cl. G06K 19/073; G06K 1/00; G06K 7/00

(52) U.S. Cl. 235/380; 235/492

(57) ABSTRACT

A system and method for using a smart card for selectively storing and accessing a plurality of travel related information and documents is provided. The system uses a smart card to store and selectively provide access to travel information. Further, the method allows a traveler to use a smart card to store and access travel documents and information throughout the duration of a trip or vacation.

### CROSS-REFERENCE

This application claims priority from Provisional Patent Application Ser. No. 61/540,201 filed Sep. 28, 2011.

### FIELD OF THE INVENTION

This invention pertains generally to a compact storage unit for travel documents, and more particularly to a smart card for storing and accessing travel information and documents and a method of using the same.

### BACKGROUND

In support of their customers, travel agencies and other travel services providers commonly use electronic tickets (e-tickets) to store information and documents needed by a traveler during a vacation, trip, cruise, and the like. After booking a vacation, the customer receives an email with an electronic link allowing access to the e-ticket. The e-ticket is typically displayed in the form of web pages that the traveler needs to print out in a paper hard copy version so that the travel information is serialized in a format that allows the user to carry and access the information as needed during the travel period. Additional travel information, such as hotel and car rental information is similarly available in the web page format.

As part of travel preparations, the traveler therefore needs to carry a hard copy of travel documents that are needed during the trip such as airplane tickets, airline information, hotel information, travel vouchers, insurance information, emergency contact information, and the like. This can be very inconvenient, as some of the travel documents may get lost or be left behind. Additionally, if the paper copies become wet or damaged, they can become illegible and useless. Another common problem when traveling is the lack of access to a functioning printer so that the traveler may print out travel related paperwork as needed. While it is common for many hotels to provide printer access in the lobby, the printer may be tied up or not practical in the event that the traveler's travel plans suddenly change creating a time crunch. It is therefore desirable to have a single convenient compact format for consolidating and storing all travel related information and that is equipped to provide secure access to this information during the travel period.

### SUMMARY

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a smart card for storing and selectively accessing travel related information and documents during a vacation. The smart card of the present invention comprises at least an integrated circuit with an electronic memory designed to collect and store information that is related to a user's vacation documents and/or information. The smart card further comprises a plurality of textual and pictorial indicia related to the user. The smart card allows the user to share the travel information at points of contact such as an airline ticket counter, a hotel check in desk, a rental car location, and other venues without the need for a printed copy of reservation documents. The textual and pictorial indicia may include specific information identifying the user and a plurality of advertising indicia including discounts or coupons.

Furthermore, in one preferred embodiment, the smart card is part of a system for electronically storing and selectively accessing a plurality of vacation information through an Application Protocol Data Unit. An authentication mechanism is used to protect the data stored on the smart card. A communication mechanism, such as a point of contact bar code or magnetic strip reader may be used to access the electronic memory unit of the smart card.

Additionally, the present invention discloses a method of using the smart card to access a plurality of travel documents and related information. Typically, a travel agency or other travel document issuing entity will issue a smart card programmed with the user's specific travel information. The user may then access and share the information as needed as desired. Other information that may be stored on the smart card may include emergency contact information or documentation or medical or insurance information. The travel information may be modified on the smart card as necessary in the event that a change in travel plans occurs, such as a flight delay.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a front perspective view of a smart card in accordance with the disclosed architecture.

FIG. 2 illustrates a rear perspective view of the smart card in accordance with the disclosed architecture.

FIG. 3 illustrates a perspective view of an integrated circuit embedded within the smart card in accordance with the disclosed architecture.

FIG. 4 illustrates a flow chart disclosing a method of using the smart card in accordance with the disclosed architecture.

FIG. 5 illustrates a flow chart disclosing a method of using the smart card in accordance with the disclosed architecture.

FIG. 6 illustrates a flow chart disclosing a method of using the smart card in accordance with the disclosed architecture.

FIG. 7 illustrates a flow chart disclosing a method of using the smart card in accordance with the disclosed architecture.

FIG. 8 illustrates a flow chart disclosing a method of using the smart card in accordance with the disclosed architecture.

### DETAILED DESCRIPTION

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

Travelers and vacationers use a wide variety of travel document such as tickets, reservations, electronic documents, and other related travel information. Presented with a plurality of travel information in a variety of different forms, a traveler must often carry or print out paper copies of electronic documents throughout the duration of the trip. The situation is exacerbated when travel plans such as reservations suddenly change, or when the trip is interrupted for a medical emergency. The present invention is designed to allow a user to store and access a wide variety of travel information in a single compact format, without the need to constantly print out documents. The invention uses a smart card that may be issued by a travel agent or other similar service provider. The smart card would store all of the travel data needed for the trip, such as airline tickets, hotel information, rental car agreements, and the like. Additionally, the smart card may be equipped with authentication mechanisms to prevent the unauthorized access of the stored information.

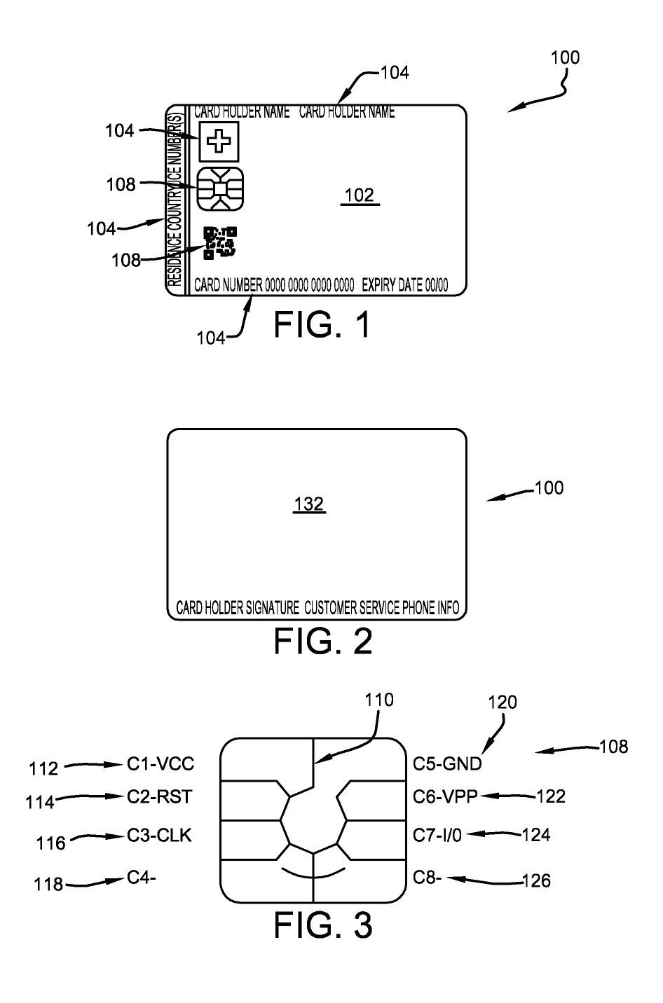

Referring initially to the drawings, FIGS. 1 and 2 illustrate a smart card 100 for storing and selectively accessing travel data in accordance with the disclosed architecture. This is advantageous as the smart card 100 allows a user to add, delete, or manipulate information storable on the smart card 100 as opposed to a memory chip card which can only execute pre-defined functions. The term “smart card” is used to describe any device capable of relating information to a particular application such as a memory card and a microprocessor card. The memory card can store a variety of data, but cannot process information. The microprocessor card has an appearance similar to a standard plastic credit card, but is imbedded with an integrated circuit chip capable of storing information, carrying out local processing of the stored information, and performing complex calculations. The microprocessor card can take the form of either a contact version of the smart card 100 which requires a card reader, or a contactless embodiment of the smart card 100 which uses radio frequencies to operate. It is common for the smart card 100 to have an operating system through which a plurality of hardware components of the smart card are managed. In addition, the operating system hosts an application written for the smart card 100, thereby extending the smart card's functionality. Functional details and characteristics of the contact smart card follow international standards developed by the International Standard Organization (ISO) and the Electrotechnical Commission (IEC) and are well known in the art.

In general the contact embodiment of the smart card 100 is comprised of a smart card body comprising a front side 102 and a back side 132, and an integrated circuit 108 embedded within the smart card 100 as is known in the art. The smart card 100 can be manufactured using one of the following materials: Polyvinyl chloride PVC), polycarbonate (PC), polyester or polyethylene terephthalate (PET), PET (polyester), PET (film), PETG, PET/PETG and PEC, as well as combinations of hard materials (like PET and PC) with soft materials such as thermoplastic elastomers (TPE) or thermoplastic polyurethane (TPU). PVC is the least expensive of the main card body materials. It is used for both the contact and contactless versions of the smart card 100, but generally has a shorter life expectancy than other card body materials. PC is a more rigid material which has a much higher resistance to damage. PET (polyester), PETF and PETG are special materials that enhance specific strengths or reduce certain weaknesses in the card body. These derivative materials are often combined with substrates to significantly enhance the physical durability for specific applications. In particular, to reduce the incidence of an antenna connection break and a contact plate separation caused by flexing and bending of the smart card 100. For example, PETF (polyester film) is a PET derivative that has very high thermal stability, mechanical strength and chemical inertness. Other preferred combinations include PET/PETG and PEC as well as combinations of hard materials (like PET and PC) with soft materials like thermoplastic elastomers (TPE) or thermoplastic polyurethane (TPU).

The front surface 102 comprises a plurality of textual and pictorial indicia 104 comprising: a residence country of a user, a card number, an expiration date, a user name, a distinct sign of a medical condition, a 2D or QR bar code 106, a customer service number, a signature line, a plurality of advertisements, and any other information that may be desired. For example, the plurality of advertisements may comprise various service offers from service providers that choose to advertise services with the travel agency issuing the smart card 100.

As illustrated in FIG. 3, embedded within the smart card 100, the integrated circuit 108 will have the characteristics defined in ISO/IEC 7816-2 and comprises a plurality of electrical contacts 110 preferably have eight in number (referred to in the chart below as C1 through C8) with the following designations:
I/O: Input or Output for serial data to the integrated circuit inside the smart card 100;
VPP: Programming voltage input (optional use by the smart card 100);
GND: Ground (reference voltage);
CLK: Clocking or timing signal (optional use by the smart card 100);
RST: Either used itself (reset signal supplied from the interface device) or in combination with an internal reset control circuit (optional use by the smart card 100). If internal reset is implemented, the voltage supply on VCC is mandatory;
VCC: Power supply input (optional use by the smart card 100).
   However, this is not meant as a limitation, as the plurality of electrical contacts 110 may number between six and twelve as needed. A preferred embodiment of the plurality of electrical contacts 110 is described as follows:

| | Desig- | |
|---|---|---|
| Contact | nation | Usage |
| C1 | VCC | Power connection through which operating |
| | 112 | power is supplied to the microprocessor chip |
| | | in the smart card 100. |
| C2 | RST | Reset line through which the IFD can signal |
| | 114 | to the smart card 100 microprocessor chip to |
| | | initiate its reset sequence of instructions. |
| C3 | CLK | Clock signal line through which a clock signal |
| | 116 | can be provided to the microprocessor chip. |
| | | This line controls the operation speed and provides |
| | | a common framework for data communication between |
| | | the IFD and the ICC. |
| C4 | RFU | Reserved for future use. |
| | 118 | |
| C5 | GND | Ground line providing common electrical ground |
| | 120 | between the IFD and the ICC. |
| C6 | VPP | Programming power connection used to program |
| | 122 | EEPROM of first generation ICC's. |
| C7 | I/O | Input/output line that provides a half-duplex |
| | 124 | communication channel between the reader and |
| | | the smart card 100. |
| C8 | RFU | Reserved for future use. |
| | 126 | |

The smart card 100 further comprises a central processing unit (CPU) and an electronic memory comprising Read Only Memory (ROM), Electrical Erasable Programmable Read Only Memory (EEPROM), and Random Access Memory (RAM). The CPU is in electrical communication with the electronic memory and interprets and executes instructions. ROM can only be written to once during production. The ROM contains most of the operating system for the smart card 100, as well as diagnostic and testing functions. The ROM creates the “secure operating system” by eliminating back doors and other system tampering by programmers. The EEPROM is used for all data and programs that need to be modified or erased. The EEPROM functions like a hard disk in a personal computer allowing the data to remain in memory even without a power source. The RAM is memory usable during a single session. As soon as power is lost, the RAM will be cleared of all data. The data may comprise security data, vacation data, rewards data, insurance data, and medical data. Vacation data may comprise airline ticket information, hotel accommodation information, rental car information, vacation reservation numbers, tour information, and the like.

Information storable on the smart card 100 may comprise the following: security data allowing authentication and authorization for access to the smart card 100 information; personal data comprising personal information such as the user's address and additional travelers; passport information; vacation data comprising reservation numbers, flight information, accommodation information, and other like services; rewards data related to customer loyalty programs; insurance information; and medical information.

A contactless embodiment of the smart card 100 is in communication with a card reader using radio waves. This capability is implemented by using a Radio Frequency Identification (RFID) tag embedded within the smart card 100. Similar to the contact embodiment of the smart card 100, details, characteristics and functional aspects have been addressed in international standards developed by the International Standard Organization (ISO) the International Electrotechnical Commission (IEC) and are well known in the art.

A hybrid or dual-interface embodiment of the smart card 100 implements both contact and contactless interface. In general the hybrid version of the smart card 100 comprises two or more embedded chip technologies such as a contactless smart chip with an antenna, a contact smart chip with a plurality of contact pads, and/or a proximity chip with an antenna all in the smart card 100 as is well known in the art.

The communication between the smart card 100 and the card reader is done using an Application Protocol Data Unit (APDU) which is defined as: a unit of data specified in an application-protocol and consisting of application-protocol-information and possibly application-user-data as is known in the art. The APDU allows communication between the smart card 100 and the card reader. The structure of an APDU for the contact version of the smart card 100 is defined by the ISO 7816 standards. For the contactless versions of the smart card 100, the communication is covered in ISO/IEC 14443-4, as mentioned supra.

A system for electronically storing and selectively accessing a plurality of travel documents and other information deemed as necessary for a vacation or a trip comprises the smart card 100 as described supra, an authentication mechanism, and a communication mechanism for sharing information. Along with the data needed for the vacation, the smart card 100 will store information needed to secure the data. The system will retain information using a Database Management System (DMS) which will allow storing the information at a more detailed level. However the smart card 100 will keep the information needed to be understood and processed as it will be a stand-alone sub-system. The smart card 100 will hold up-to-date information while the DMS will hold all additional information. If deemed necessary the DMS for any of the system components can implement a multi tenancy feature so the system will be able to host and serve multiple client organizations as is well known in the art.

For authentication purposes the smart card 100 will use a personal identification number (PIN) to authenticate the card holder's identity in order to be able to perform operations with the smart card 100. The PIN may be set to expire at the end of the vacation, or at a different time as desired. In order to reset the PIN, the card holder will need to authenticate himself/herself using a security code comprising a sequence of numbers or symbols, similar to the PIN, which will be used as mechanism to override the PIN and it will allow the cardholder to reset the PIN. The PIN and security code implementation can follow the standard ISO/IEC 9564 which defines the principles and requirements for PIN management in banking and financial services as is well known in the art.

In the scope of data protection, cryptographic algorithms may be used to encrypt the data, in order to ensure the data's confidentiality. Encryption will be used for the communication processes between different components of the system as well as for the data stored on the smart card 100. In other words, the messages exchanged as part of the communication process between the smart card 100 and terminal application will be encrypted. The terminal application is a software application that can communicate with the smart card 100 through the card reader or in other ways as known in the art. The terminal application can be hosted on any device that provides such capabilities such as personal computers, tablet personal computer, or mobile devices (smart phones, handheld devices etc). For communication between components it might be desirable to employ data compression to have a faster communication or to overcome the issues raised by a slow network.

Data integrity, as part of data security, pertains to preserving authenticity of the data in the message assuring that the data was not altered during the message transmission between the sender of the message and the receiver. The authenticity area of data security is concerned with the identity of the parties involved in a communication. More specifically, the messages use a digital signature to link the public key to the user and/or an organization and to validate the identity of the entity providing the key. This can be implemented using a message authentication code or a digital certificate. Message authentication code (MAC) is a block of data generated based on the message. The MAC algorithm is hash function that accepts as input a key and a part of the message and outputs the value named Message Authentication Code. The Message Authentication Code maintains the data integrity of the message and guarantees the authenticity, however it does not implement the property of non-repudiation. A preferred protection can be ensured using the digital certificates. The digital certificates are provided by a certification authority who acts as trusted third party. Preferred protection comprises a data model that allows storing the information for the system.

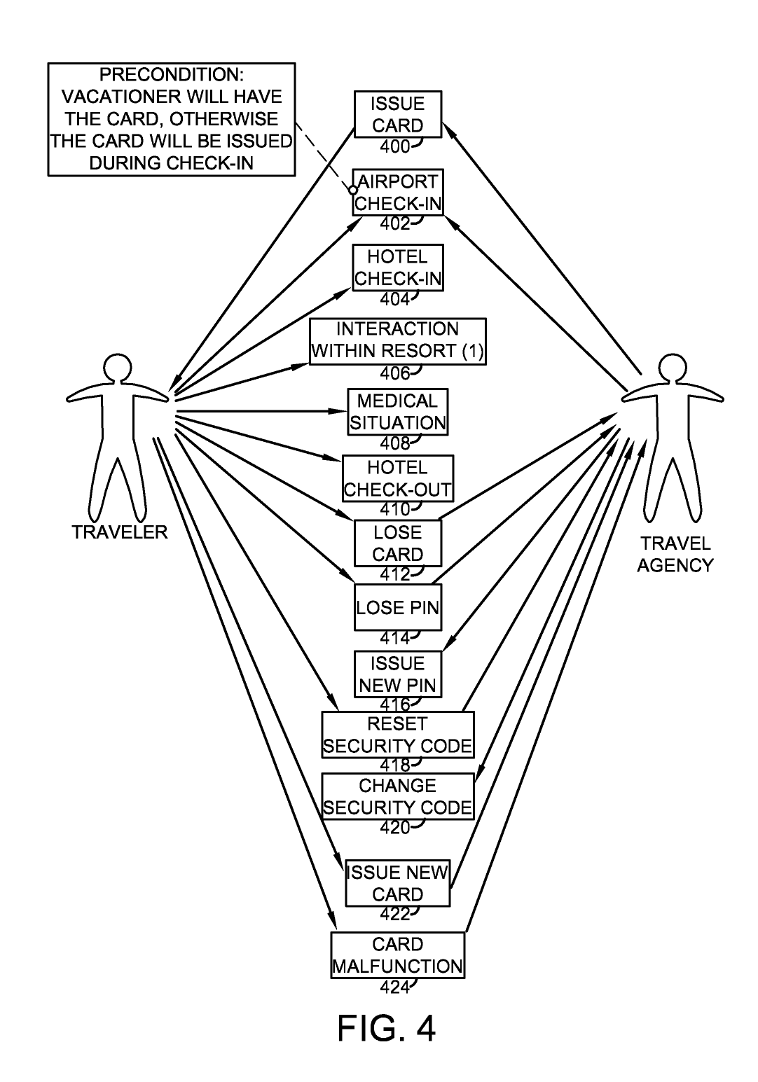

FIGS. 4-8 illustrate preferred methods of using the smart card 100. FIG. 4 identifies the usage scenarios of the smart card 100 for the interaction between the Vacationer and the Vacation Agency. At 400 the smart card 100 is issued by the Travel Agency to the Traveler, and will contain the information needed for the vacation. At 402 the flight information is stored in the smart card 100 can be used for airport check-in. At 404 the smart card 100 will be used for check-in or at 410 at check-out from a hotel or other accommodation as the smart card 100 has stored the accommodation reservation information. Any changes regarding the stay will be stored on the smart card 100 at 406. The smart card 100 stores the services provided by the Travel Agency.

Having stored the cardholder Medical Information as well as the Insurance Data the smart card 100, at 408 the smart card 100 can be used in the event of a medical emergency during the vacation. With the medical information stored on the card a healthcare professional will be able to have an understanding of cardholder medical situation and make the proper decision regarding his/her medical treatment, even in the event that the cardholder is unconscious. 412-422 provide an additional or an alternative flow, meaning there are usage scenario treating various problems that can appear during the use of the smart card 100 comprising the following: 412 and 422 cover the loss of the smart card 100 card, in which case a replacement will be issued by the Travel Agency, while the lost card will be marked as invalid; 414 and 416 depict the situation when the PIN needed for authentication is lost/forgotten, in which case a new PIN will be issued by the Travel Agency, after the Travel Agency confirms the ownership of the smart card 100 based on the Security Code and/or other well accepted identification such as a driver's license; 418 and 420 involve situations when a new security code needs to be issued after the Travel Agency confirms ownership of the smart card 100 based on the security code and/or other identification; 424 covers the event of a malfunction of the smart card 100 due to any damage or other deficiency.

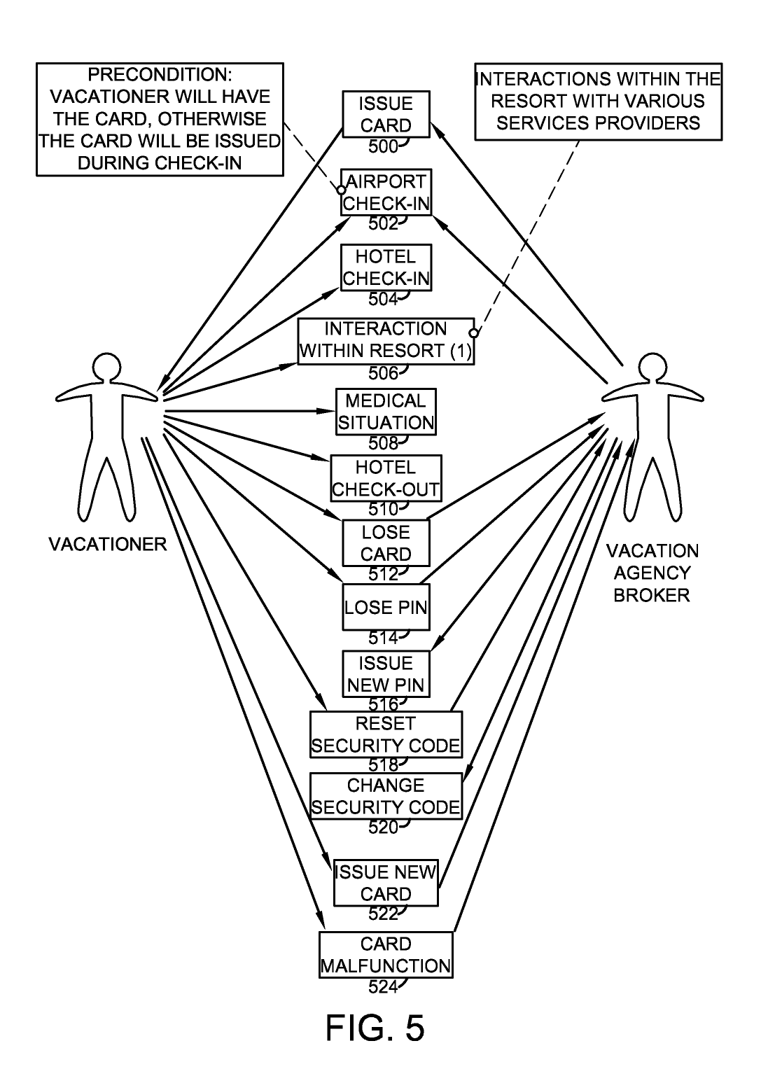

FIG. 5 identifies the usage scenarios of the smart card 100 for the interaction between the Traveler and the Travel Agency Broker or Travel Agent. At 500 the smart card 100 will be issued to the Traveler by the Travel Agency and will contain the information needed for the vacation. At 502 the flight information stored the smart card 100 can be used for airport check-in. At 504 the smart card 100 may be used for check-in into, or at 510 at check-out from a hotel or other accommodation. Any changes regarding the stay will be uploaded to and stored on the smart card 100 at 506. The smart card 100 stores the services provided by the Travel Agency, directly or indirectly, through its partners; therefore the smart card 100 can be used by the Traveler during the stay to benefit from the services provided or to purchase additional services offered as desired.

Having stored the cardholder Medical Information as well as the Insurance Data the smart card 100, at 508 can be used in the case of a medical emergency. With the medical information stored on the card the healthcare professional will be able to have an understanding of cardholder medical situation. 512-522 provide an additional or an alternative flow, meaning there are usage scenario treating various problems that can appear during the use of the smart card 100 comprising the following: 512 and 522 cover the loss of the smart card 100 card, in which case a replacement will be issued by the Travel Agency, while the lost card will be marked as invalid; 514 and 516 depict the situation when the PIN needed for authentication is lost/forgot, in which case a new PIN will be issued by the Travel Agency; 518 and 520 cover the case when a new security code needs to be issued, after the Travel Agency confirms the ownership of the smart card 100; 524 covers the event of the malfunction of the smart card 100, due to any damage or other deficiency.

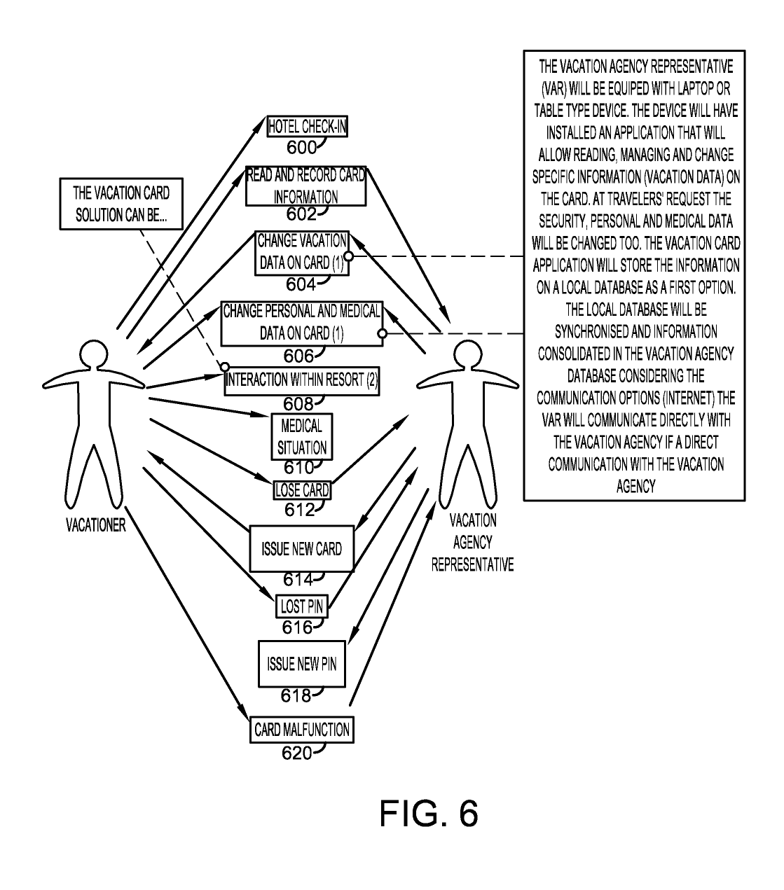

FIG. 6 identifies the usage scenarios of the smart card 100 for the interaction between a Vacationer and a Vacation Agency Representative in a vacation resort or any other vacation destination. Some of the use steps detailed below are similar to the ones between the Traveler and the Travel Agency as described supra. At 600, the smart card 100 may be used for check-in to a hotel. At 602, the smart card 100 communicates with the card reader at the hotel. However, during the vacation, some of the information might change (accommodation, new services provided, etc) in which case the corresponding information will be updated on the smart card 100 at 604. In the event that the Vacationer notices any discrepancy between the information stored on the smart card 100 and the reality, the Vacationer might request an update of the information on the smart card 100 at 606. In case any other information might change during the vacation, the data on the smart card 100 maybe updated as well.

The smart card 100 stores the services provided by the Vacation Agency, therefore at 608, the smart card 100 can be used by the Vacationer during his/her stay to benefit from the services provided or to purchase additional services offered. Having stored the cardholder medical information as well as the insurance data, the smart card 100 at 610 can be used in the case of a medical situation as described supra. 612-620 provide an additional or an alternative flow of the smart card 100. 612 and 614 cover the loss of the smart card 100, in which case a new card will be issued by the Vacation Agency. 616 and 618 depict the situation when the PIN needed for authentication is lost/forgot, in which case a new PIN will be issued by the Vacation Agency. 620 depicts the event of the malfunction of the smart card 100, due to any damage to the smart card 100 or any other deficiency.

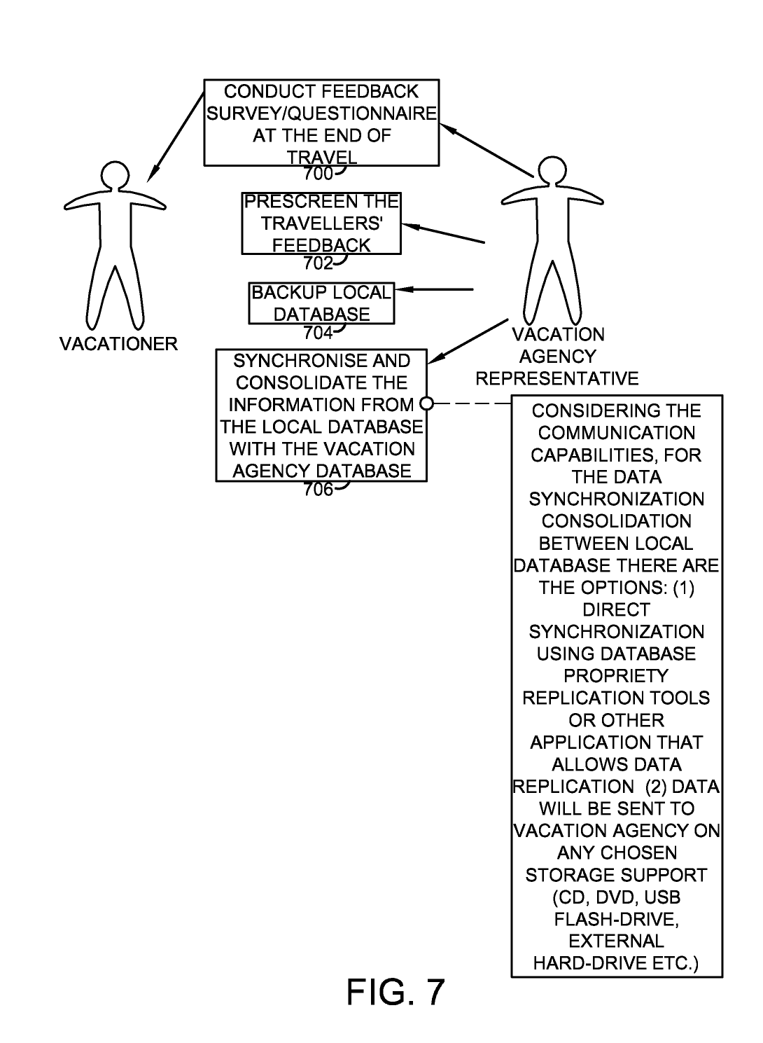

FIG. 7 illustrates the actions that may be performed by the Vacation Agency Representative who activates at the vacation destination. At 700 the Vacation Agency Representative might conduct a survey/questionnaire at the end of the vacation so to get the feedback and maybe new proposals to improve the vacation experience from Vacationer. At 702 the surveys may be pre-screened to eliminate the surveys that don't provide any meaningful data and/or to perform a de-duplication activity to eliminate the surveys that provide redundant data. 704 and 706 illustrate activity needed to be executed by the Vacation Agency Representative in the event that a local database is not connected to a Vacation Agency Data Center. 704 depicts a backup of the database that supports the application will be performed at the end of a vacation period. At 706 the local database will be synchronized with Vacation Agency Database, so the Vacation Agency will have up to date data regarding its customers.

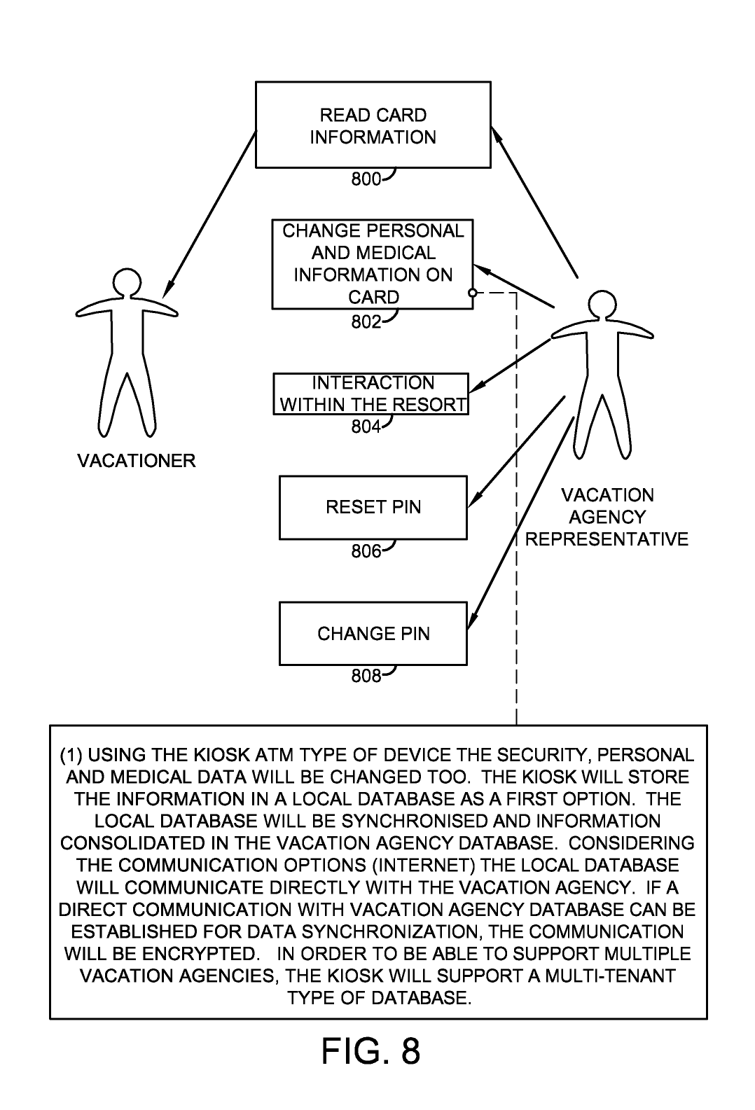

FIG. 8 represents the usage steps of the smart card 100 when a Point of Service in the form of a machine service, similar to the ATMs, will be implemented. The method starts at 800 where the information stored on the smart card 100 is accessed and read. At 802 the Vacationer will have the ability to change his/her own personal and medical data on the smart card 100. At 804 the Vacationer can verify the services provided by the Vacation Agency throughout the vacation. At 806 and 808 the Vacationer can reset or change the PIN for the smart card 100 based on Security Code.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A smart card for storing and selectively accessing vacation data, the smart card comprising:
a front surface comprising a plurality of textual and pictorial indicia;
an integrated circuit embedded within the smart card comprising a plurality of electrical contacts and an electronic memory; and
a back surface.

2. The smart card of claim 1, wherein a smart card material comprises: polyvinyl chloride, polycarbonate, polyester or polyethylene terephthalate, polyester film, thermoplastic elastomers, thermoplastic polyurethane, or any combination thereof.

3. The smart card of claim 1, wherein the plurality of textual and pictorial indicia comprises a card user's country of residence, an emergency contact number, a card number, an expiration date, a card holder's name, an indicia of a medical condition, a 2D code, a customer service number, or a plurality of advertising indicia.

4. The smart card of claim 3, wherein the electronic memory stores security data, personal data, vacation data, rewards data, insurance data, or medical data.

5. The smart card of claim 4, wherein the vacation data comprises: airline ticket information, hotel accommodation information, rental car information, a vacation reservation number, or tour information.

6. The smart card of claim 1, wherein the smart card interacts with a plurality of computers and smart mobile devices and applications through an Application Protocol Data Unit.

7. The smart card of claim 1, wherein the smart card is a contact smart card, a contactless smart card, or a hybrid dual-interface smart card.

8. A system for electronically storing and selectively accessing a plurality of vacation documents with a smart card, the system comprising:
the smart card comprising:
an electronic memory unit;
an integrated circuit for storing and accessing the electronic memory unit,
wherein the electronic memory unit is in electrical communication with the integrated circuit and stores data comprising vacation information;
the system further comprising:
an authentication mechanism; and
a communication mechanism for sharing vacation information.

9. The system of claim 8, wherein vacation information is uploaded onto the smart card and electronically stored within the electronic memory unit and accessible at a point of contact with a smart card reader.

10. The system of claim 8, wherein the integrated circuit comprises a power connection, a reset line, a clock signal line, a ground line, a programming power connection, or an input/output line.

11. The system of claim 10, wherein the integrated circuit comprises approximately between six and twelve electrical contacts.

12. The system of claim 8, further comprising a central processing unit in communication with the electronic memory unit.

13. The system of claim 12, wherein the electronic memory unit comprises Read Only Memory, Random Access Memory, or Electrical Erasable Programmable Read Only Memory.

14. The system of claim 8, wherein the smart card further comprises a radio frequency identification tag.

15. A method for using a smart card to store and access a plurality of vacation documents, the method comprising the steps of
issuing a smart card by a vacation agency for programming with the vacation information;
programming flight information on the smart card;
downloading hotel information on the smart card;
storing other travel services information on the smart card;
programming medical and insurance information on the smart card;
downloading alternative flow information on the smart card; and
accessing information on the smart card by a user.

16. The method of claim 15, further comprising the step of invalidating the smart card if lost or stolen.

17. The method of claim 16, further comprising the step of utilization a personal identification number for authentication.

18. The method of claim 17, further comprising the step of modifying uploaded travel documents as vacation plans change.

19. The method of claim 18, further comprising the step of notifying a cardholder of discrepancies between stored information and changes to a vacation itinerary.

20. The method of claim 19, further comprising the step of accessing the vacation services information at a point of contact.
